(19) United States
(12) Patent Application Publication
(10) Pub. No.: US 2011/0137763 A1
(43) Pub. Date: Jun. 9, 2011

(54) System that Captures and Tracks Energy Data for Estimating Energy Consumption, Facilitating its Reduction and Offsetting its Associated Emissions in an Automated and Recurring Fashion

(76) Inventor: Dirk Aguilar, San Francisco, CA (US)

(21) Appl. No.: 12/947,640

(22) Filed: Nov. 16, 2010

Related U.S. Application Data
(60) Provisional application No. 61/285,072, filed on Dec. 9, 2009.

(51) Int. Cl. G06Q 99/00; G06F 1/26; G06Q 30/00

(52) U.S. Cl. 705/30; 700/291; 705/317; 705/347; 705/400

(57) ABSTRACT

A system and method for automatically and routinely capturing and tracking energy data, estimating energy consumption, facilitating the reduction of consumption, and offsetting energy emissions.

### CROSS-REFERENCE TO RELATED APPLICATIONS

This application claims priority to U.S. Patent Application No. 61/285,072 filed 9 Dec. 2009, which is hereby incorporated by this reference.

### BACKGROUND OF THE INVENTION

1. Technical Field

The invention relates to the field of energy management. More specifically, the invention relates to a system and method for automatically and routinely capturing and tracking energy data, estimating energy consumption, facilitating the reduction of consumption, and offsetting energy emissions.

2. Description of the Related Art

Energy consumption and efficiency is an altruistic, economic, and regulatory concern for many contemporary businesses and individuals. Reduction of energy usage and efficient energy usage is considered socially-responsible and can also be used to boost the image of a business. Additionally, conserving energy and using energy more efficiently oftentimes saves money, entitles a business to tax credits, or otherwise creates some economic advantage.

Energy efficiency and consumption are also widely regulated by local, state, and Federal laws. Indeed, the United States Congress has created a number of federal agencies to monitor and regulate energy consumption and emissions.

For example, the Federal Energy Regulatory Commission manages and regulates interstate electricity sales, wholesale electric rates, hydroelectric licensing, natural gas pricing, and oil pipeline rates, liquefied natural gas terminals, interstate natural gas pipelines, and non-federal hydropower projects, among other duties. Likewise, the Environmental Protection Agency regulates the energy emissions for individuals, businesses, and even governments.

Despite the large amount of regulation, businesses wishing to monitor and manage their energy consumption, amount of emissions, and compliance with regulations have few tools to assist them.

There is also a growing trend of individuals and families managing household energy usage and efficiency. However, current solutions fall short on automation, user friendliness, interoperability, scalability, optimization, access to offset markets, etc.

### SUMMARY OF THE INVENTION

In view of the foregoing, the invention provides systems and methods for automatically and routinely capturing and tracking energy data, estimating energy consumption, facilitating the reduction of consumption, and offsetting energy emissions.

Some embodiments of the invention involve an energy management system having processing engine and a plurality of processing modules especially configured for automatically and routinely capturing and tracking energy data, estimating energy consumption, facilitating the reduction of consumption, and offsetting energy emissions, as well of other functions.

Some embodiments of the invention involve methods for providing energy and environmental management services including the steps of establishing a plurality of customer accounts, collecting account-holder energy information, automatically analyzing the collected energy information, generating optimization information, identifying opportunities for energy reduction and environmental improvements, providing recommendations to the consumers, and giving consumers tools for dynamically modifying energy usage using the recommendations.

Some embodiments of the invention involve methods of managing energy emissions and offering access to an emission offset market including the steps of establishing a plurality of customer accounts, automatically or manually collecting account holder energy emission information, automatically analyzing the collected energy information, and determining if emissions offsets are required to comply with regulations or if a customer has indicated that he wishes to enter a voluntary emissions market.

### BRIEF DESCRIPTION OF THE DRAWINGS

FIG. 1 illustrates an exemplary method for providing energy and environmental management services according to some embodiments of the invention;

FIG. 2 illustrates another exemplary method of managing energy emissions and offering access to an emission offset market according to some embodiments of the invention;

FIG. 3 illustrates an energy management system including a processing engine according to some embodiments of the invention;

FIG. 4 is a block schematic diagram of a machine in the exemplary form of a computer system within which a set of instructions may be programmed to cause the machine to execute the logic steps of the invention;

FIG. 5 illustrates a hosted consumer solution according to some embodiments of the invention;

FIG. 6 illustrates a local consumer solution according to some embodiments of the invention;

FIG. 7 illustrates a hosted corporate solution according to some embodiments of the invention;

FIG. 8 illustrates a local corporate solution according to some embodiments of the invention; and

FIG. 9 illustrates a representation of user profiles according to some embodiments of the invention.

### DETAILED DESCRIPTION OF THE INVENTION

Systems and methods are provided for automatically and routinely capturing and tracking energy data, estimating energy consumption, facilitating the reduction of consumption, and offsetting energy emissions.

The presently preferred embodiments of the invention involve an energy management system including a processing engine for providing energy management services to users via server-based, web-based, client-based, or mobile-based applications. In some embodiments of the invention, the management system is employed by individual or corporate consumers for their energy and environmental management. In some other embodiments of the invention, the system is employed by any entity or group of people for their combined energy and environmental management.

For example a corporate customer may utilize the system in order to reduce cost and promote good corporate responsibility. A corporate customer may also leverage the system as an energy and environmental product for the benefit of his own customers. Customers may have one or several profiles. For example an individual may chose to have one personal and one professional profile.

Some embodiments of the invention involve an energy management system for providing energy management services in transportation systems. For example, some embodiments of the invention are applied in airline and automotive implementations for managing energy usage above and beyond merely tracking electricity and gas usage.

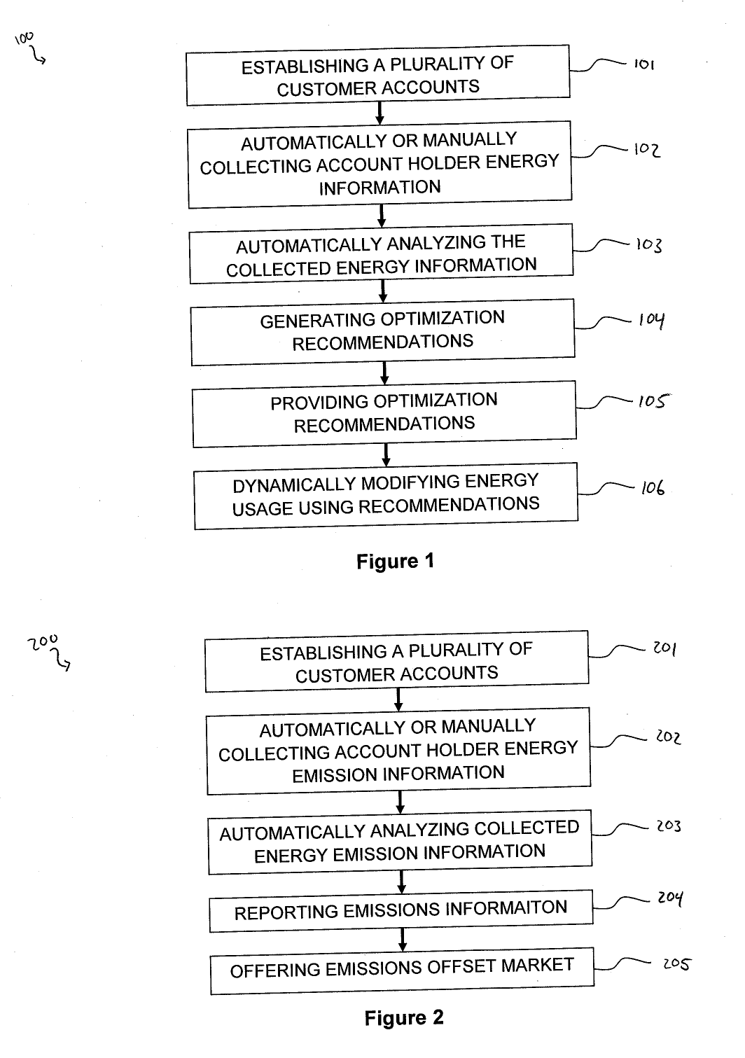

FIG. 1 illustrates an exemplary method 100 for providing energy and environmental management services according to some embodiments of the invention. The method 100 begins with establishing a plurality of customer accounts 101. As explained above, method is available for individual users, corporate users, and group users. The step of establishing a plurality of customer accounts 101 involves establishing user profiles for displaying aggregate information on a particular user, group, or the entire community. In some embodiments, an individual user may have multiple profiles. For example, in some embodiments of the invention, a user may have a personal profile and a professional profile. Alternatively a single profile may be used and separate tags attributed to different purposes. In some embodiments, a group profile represents the aggregate of its participating users or user profiles. For example a company may have a group profile and include its employees' professional profiles, but not their personal ones. In some embodiments, a community profile represents the aggregate of all of its users and groups.

The method 100 continues with collecting account-holder energy information 102. In some embodiments of the invention, the goal is to streamline energy data collection via automation in order to save the user time and effort. In some embodiments of the invention, different data collection methods are employed based on the user's particular circumstances and preferences. In some embodiments, the user edits or adds data manually.

The presently preferred embodiments of the invention involve an automated system for collection of energy data from any data source or collection of data sources on an ongoing basis. Data collection methods include, but are not limited to: financial institutions, local client applications, mobile device applications, software system integration, travel planning tools, environmental data providers, energy monitors, vehicle electronics, and user account APIs.

In some embodiments of the invention, data collection from financial institutions includes a partner bank issuing a co-branded payment card and making transactional data available to the system. In some other embodiments, financial institutions issue a banking product that may be fully embedded in and hosted by financial institutions as an environmental service for their customers.

In some embodiments of the invention, data collection from client applications comprises a local program for retrieving energy-related information from data sources and forwarding it to the system. Examples include a browser extension, plug-in or add-on that communicates with a system website or a full-scale program that handles energy management locally.

In some embodiments of the invention, data collection from mobile applications involves accessing data sources via a smart phone and forwarding energy information to system servers.

In some embodiments of the invention, data collection via system integration involves extracting energy-related data from other applications employed by the user. Examples include personal finance software or corporate billing applications.

In some embodiments of the invention, data collection involves data pulls, upon user consent, from financial institutions, travel planners, energy monitors and utilities accounts via APIs or screen scraping and extracting energy-related information directly.

Some embodiments of the invention involve manual collection of energy data in order to enhance, complement or correct automatically obtained data. In some embodiments of the invention, manually entered information may be altered at any time as changes arise, and these changes may be time-stamped. Manual data includes, but is not limited to manually entering information about a user's home, transportation information, behavioral information, and energy goals.

Some examples of home information readily available for manual upload include type of home, surface area, energy sources, energy source consumption rating, insulation type and amount, types of appliances, other types of energy using devices, and clean energy purchases. Some examples of transportation information readily available for manual upload include methods of transportation used, number and type of vehicles, annual mileage, and number and length of annual flights. Some examples of behavioral information readily available for manual upload include energy management habits, waste management habits, nutritional habits. Finally, some examples of goals readily available for manual upload include desired energy efficiency, desired cost savings, and desired emissions reduction and offsets.

Although specific examples of energy collection are explicitly mentioned herein, it will be apparent to those having ordinary skill in the art that any automatic or manual data collection technique, now known or later developed, are equally applicable for carting out the invention.

Referring again to FIG. 1, the method 100 continues with automatically analyzing the collected energy information 103 and generating optimization information 104, thereby identifying opportunities for energy reduction and environmental improvements. Energy analysis and generation of optimization reports is discussed in greater detail below.

Next, the optimization recommendations are provided to the consumers 105. Finally, the consumers are given tools for dynamically modifying energy usage using the recommendations 106.

Those with ordinary skill in the art having the benefit of this disclosure will realize that the method 100 described above is intended to be illustrative, but not limiting. For example, some other embodiments of the invention focus on automatically managing emissions records and offering users access to an emissions offsetting market. Some embodiments of the invention involve regulatory offset compliance, while other embodiments involve voluntary offset purchases, or both regulatory and voluntary offset markets.

FIG. 2 illustrates another exemplary method 200 of managing energy emissions and offering access to an emission offset market according to some embodiments of the invention. The method 200 of FIG. 2 begins with establishing a plurality of customer accounts 201 and automatically or manually collecting account holder energy emission information 202. The method 200 continues after the customer information is collected with automatically analyzing the collected energy information 203, thereby determining if emissions offsets are required to comply with regulations or if a customer has indicated that he wishes to enter a voluntary emissions market. The emissions information is reported to the customers 204 and an offset market is offered to consumers 205.

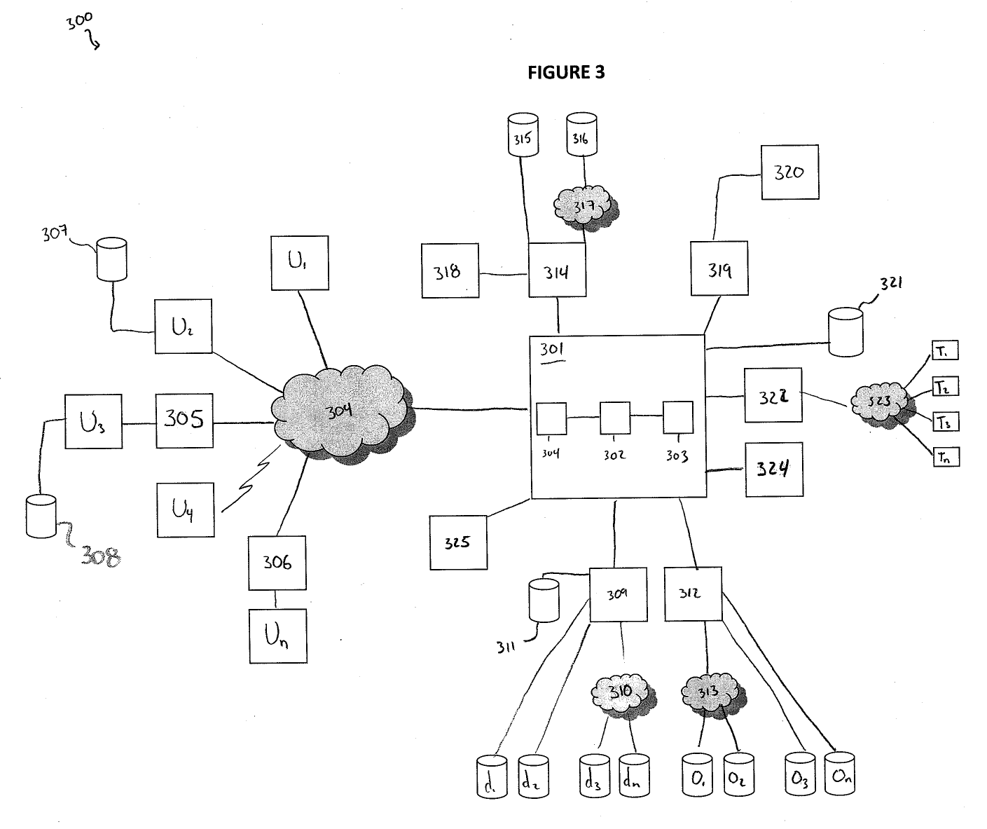

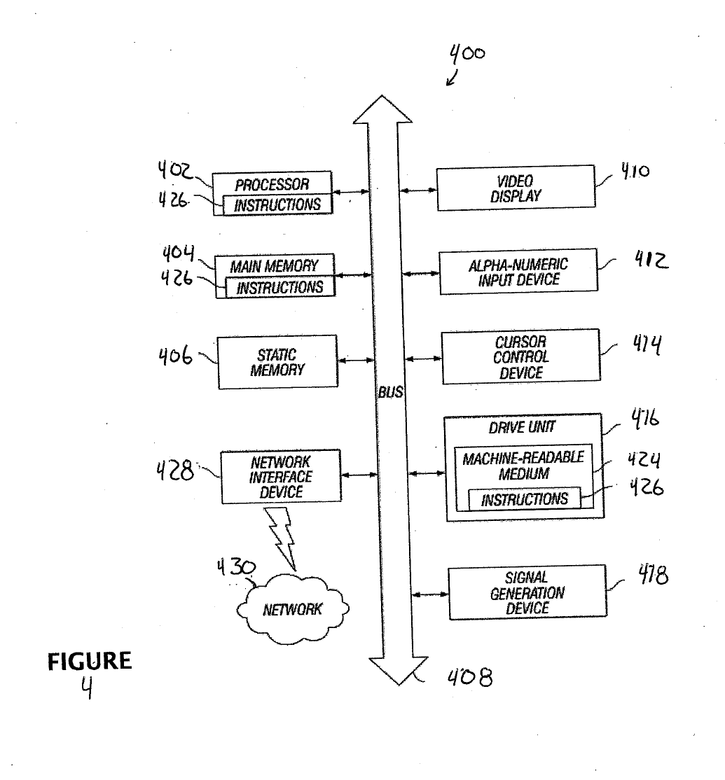

The various processing steps of invention are performed with a processing engine especially configured for carrying out the invention. For example, FIG. 3 illustrates an energy management system 300 including a processing engine 301 according to some embodiments of the invention.

The processing engine 301 comprises a processor 302 operatively coupled with a memory device 303 and a network interface 304.

### System Users

The processing engine 301 is available by a plurality of users U₁, U₂, U₃, U₄, . . . Uₙ via a graphical user interface via a network 304. In various embodiments of the invention, the energy management system 300 comprises web-, server, client- or mobile-based applications.

In some embodiments of the invention, the energy management system 300 is employed by consumers for their own energy and environmental management. In some embodiments of the invention, the energy management system 300 is also employed by any entity or group of people for their combined energy and environmental management. For example a corporate customer utilizes the energy management system 300 in order to reduce cost and promote good corporate responsibility. A corporate customer may also leverage the energy management system 300 as an energy and environmental product for the benefit of his own customers.

As explained in greater detail below, customers can have one or several profiles. For example an individual can chose to have one personal and one professional profile.

In various embodiments of the invention, the users U₁, U₂, U₃, U₄, . . . Uₙ access the processing module 301 either using a hosted browser-based interface or via individual local client applications 305, 306 for collecting and processing energy information, wherein only some information is transferred to the processing module 301. Likewise, one or more users U₄ can access the energy management system 300 using a mobile electronic device.

In some embodiments of the invention, one or more of the users U₁, U₂, U₃, U₄, . . . Uₙ are operatively coupled to local memory 307, 308 containing personal or corporate energy records.

Various arraignments are available to offer users with the processing engine 301, including hosted consumer solutions, local consumer solutions, hosted corporate solutions, and local corporate solutions, as will be discussed in greater detail below.

The processing engine 301 is operatively coupled with a plurality of processing modules for performing specific processing tasks. In the various embodiments of the invention, the plurality of processing modules may or may not interact and system users preferably may chose which modules they leverage and how.

### Energy Assessment Module

In the presently preferred embodiments of the invention, the processing engine 301 is coupled with an energy assessment module 309. The energy assessment module 309 is configured for automatically collecting customers' energy information by accessing a variety of data sources on an ongoing basis.

Preferably, energy data is stored in a number of locations d₁, d₂, d₃, . . . , dₙ and the data may be available in actual or equivalent energy values, the latter of which may require a calculation and conversion process. In various embodiments of the invention the data locations d₁, d₂, d₃, . . . , dₙ are either available to the energy assessment module 309 locally or via a network 310. Preferably, the energy assessment module is coupled with a central repository 311. In some embodiments of the invention, some or all of the data locations d₁, d₂, d₃, . . . , dₙ are third party providers including, but not limited to financial institutions, local client applications, mobile device applications, software system integration, travel planning tools, environmental data providers, energy monitors, vehicle electronics, and user account APIs.

According to some embodiments of the invention, data access is granted by the user and each data source can be tagged. Data sources include, but are not limited to: smart meter hardware and software; energy monitors; online utility accounts; financial institution accounts; billing or payment notifications; payment transactions; personal finance software; geo applications; travel organizers; corporate finance applications; Enterprise Resource Planning (ERP) systems; and Customer Relationship Management (CRM) systems.

In some embodiments of the invention, energy assessment module 309 is tied in with one or more personal finance software providers that aggregate data from users' various bank and credit card accounts, thereby providing the energy assessment module a simple way to track energy consumption. The personal finance software providers may also be connected to utility accounts, airline mileage accounts, etc. In these situations, the energy assessment module 309 can process actual energy and travel data rather than relying on payment transaction amounts.

In some embodiments of the invention, the energy assessment module 309 includes an energy tracking mechanism which leverages so-called Enhanced Level II and Level III data for the calculation of energy usage. Using Enhanced Level II and Level III data capture techniques, major payment card companies are able to capture information such as flight itineraries and purchased fuel volume at the point of sale, and pass it through their payment processing systems. Accordingly, in some embodiments, the energy assessment module 309 obtains this information via partnerships with the card company. Using the advanced data, the energy assessment module 309 can calculate energy usage more easily and accurately than by using the transaction amount itself.

In some embodiments of the invention, the energy assessment module 309 uses historic profiling to assess energy usage. Oftentimes, financial institutions store payment transactions during varying periods of time, some for several years. Historic payment data allows the system to retroactively profile the user and deliver key benefits. For example, the user can view at least a basic profile during the first session without signing up, establish data streams, and let the system track him for a set period before getting any value out of it.

Likewise, the user's past energy and emissions balance can be used as a baseline for future analysis. Analysis includes the impact of using the system and also the resulting calculation of carbon credits.

Another benefit of using historic information derives from the fact that some user incentives may encourage fraudulent activities. For example the user could shift certain energy payments to a new credit card and appear to be saving energy if he is not tracking this particular card. The use of historic information can better identify such activities if it knows how the user has behaved before even using the system.

Finally, the customer may also manually provide any and all information himself. For example, user can upload energy information from the local memory 307, 308 of a client computer or mobile device. Manually provided information allows the system to create a framework of the customer's energy and environmental profile.

In some embodiments of the invention, the automatically obtained energy information may be divided into two sub-categories: actual energy information; and energy-related information. Actual energy information is measured in traditional energy units, such as kilowatt hours (kWh) or British Therms Unit (BTU). For example, actual energy information can be automatically retrieved from smart meter hardware or software, utilities accounts, or internal corporate servers and it may be stored in the central repository 311.

In some embodiments of the invention, energy-related information is expressed in non-energy units, such as, for example, a monetary amount. Energy-related information may be retrieved from bank accounts, energy billing or payment notifications, personal finance software, internal corporate servers, or mobile devices. The system is configured to convert energy-related information into actual energy data. For example, it can do so by dividing a gasoline charge by the average gasoline price on the purchase date and location, and multiplying it with the energy amount contained in gasoline. Once the actual energy amount has been determined, the system can store it in the central repository 311.

The customer can also manually provide any and all information himself. Depending on the customer's circumstances, such as lifestyle, personal preferences and existing technical environment, he can chose to employ some or all system applications. While certain applications are essential for the system to function, they may also be complementary, thereby contributing to data completeness and accuracy, as well as minimizing manual data entry on behalf of the customer.

Manually provided information allows the system to create a framework of the customer's energy and environmental profile. The information provided can include the customer's type of home, number of vehicles driven, weekly miles commuted, energy goals and many more.

In some embodiments of the invention, the energy assessment module 309 provides the one or more users U₁, U₂, U₃, U₄, . . . Uₙ with an event log for viewing a summary of their energy usage. According to these embodiments, the system allows the user to trace back how energy and emissions balances were calculated. It also allows the user to make edits. For example, the one or more user can tag entries in the event log, i.e. personal vs. professional, household member, etc. The user can also merge entries or eliminate duplicates. Likewise, the user can split entries if portions of the energy and emissions entry should count towards more than one user. Finally, the user can enter exclusions if an event should not actually count towards balances at all.

In the presently preferred embodiments of the invention, the energy assessment module 309 aggregates the energy data and computes an estimated energy consumption balance. Preferably, this aggregation is performed on a routine and ongoing basis.

Based on the user's estimated energy usage, the energy assessment module 309 computes the user's estimated environmental impact. Ideally, the energy assessment module 309 employs methodologies which are accredited by third parties, such as government agencies, universities or research groups. Preferably, environmental estimates are produced on an ongoing basis.

In the presently preferred embodiments of the invention, the information collected and analyzed by the energy assessment module 309 is reported to the one or more users U₁, U₂, U₃, U₄, . . . Uₙ, as explained in greater detail below.

### Optimization Module

In the presently preferred embodiments of the invention, the processing engine 301 is also coupled with an optimization module 312.

In the presently preferred embodiments of the invention, the optimization module 312 analyzes estimates and provides recommendations on how to reduce energy usage. In some embodiments, the optimization module collects other useful data from local and network 313 locations o₁, o₂, o₃, . . . , oₙ which may be used in providing recommendations.

In some embodiments of the invention, the system may identify opportunities for energy reduction and environmental improvements. These opportunities are determined by factors, which include but are not limited to: automatically or manually collected data; benchmarking against geographic and demographic statistics; benchmarking against other user data; specific criteria that stand out, such as the use of outdated appliances; incandescent light bulbs; or common sense.

Recommendations may be embedded in a work flow environment, thereby allowing the customer to manage recommendations and track the impact of his actions against his consumption and goals.

The optimization module 312 is configured to provide specific energy reduction recommendations, along with estimated cost and impact of each. Examples of recommendation include, but are not limited to recommendations regarding home energy use, transportation energy use, and user behavior.

A non-inclusive list of specific recommendations regarding home energy use include lowering the water heater temperature, insulating the user's home, purchasing clean energy from the user's utility, installing solar panels, and replacing incandescent light bulbs with halogen ones.

A non-inclusive list of specific recommendations regarding transportation energy use include evaluating public transportation for certain trips, turning off vehicles during idle times of a certain minimum length, keeping tire pressure to an optimum, assisting users in their vehicle purchase decision, investing in video conferencing equipment to reduce the amount of business travel, and including environmental practices of airlines as an air travel selection criterion.

A non-inclusive list of specific recommendations regarding behavioral adjustments to reduce energy use include turning off lights when absent, recycling, and composting.

One specific example of a recommendation is for a user with high transportation emissions or a high gasoline expense. This example involves the optimization module 312 informing the consumer that their vehicle can run on flex-fuel and that alternative fuel stations exist within five miles of the household zip code and that switching to flex-fuel would reduce the vehicle carbon footprint by 14% and save $20 in monthly fuel cost.

Another specific example of a recommendation is for a user with high heating expenses. This example involves the optimization module 312 educates the user on programmable thermostats. The advice can conclude that a seemingly large investment in a smart thermostat would pay for itself within 3.5 years, save $10 of monthly gas usage then after and reduce emissions from heating by 15% without sacrificing comfort.

In some embodiments of the invention, the optimization module 312 is configured to categorize recommendations by type, cost effectiveness and ease of execution. The optimization module 312 is also configured to provide task management functionality, allowing the user to interact with each of the recommendations. Example interactions include, but are not limited to: status (i.e. pending, accept, dismiss, already done, in progress, completed); date (i.e. start date, end date, last modified); notes; and tags. In some embodiments, status changes and dates are time-stamped with the intent to measure and report the impact of single or aggregate actions.

In some embodiments of the invention, the optimization module 312 is configured to categorize recommendations by type, cost effectiveness and ease of execution. The optimization module 312 is also configured to provide task management functionality, allowing the user to interact with each of the recommendations. Example interactions include, but are not limited to: status (i.e. pending, accept, dismiss, already done, in progress, completed); date (i.e. start date, end date, last modified); notes; and tags. In some embodiments, status changes and dates are time-stamped with the intent to measure and report the impact of single or aggregate actions.

As discussed in greater detail below, the energy management system 300 includes a social module 322 configured to allow users to share the actions they have taken and the impact they have achieved with others. This will create a database of case studies and encourage more users to do the same. In one specific example, a first user replaces a refrigerator with a more energy-efficient one on a given date and is able to see electricity savings of a certain amount each month moving forward. According to this example, the optimization module 312 could be coupled with a lead generation program, managed by an administrative module (discussed below), whereby the application directs a second user to a vendor who sells the more efficient unit. According to this example, the first user could be compensated for each such referral using virtual currency, merchant coupons, etc.

### Offsetting Module

In the presently preferred embodiments of the invention, the processing engine 301 is also coupled with an offsetting module 314. The offsetting module 314 is configured to allow the user to purchase emissions offsets, so his total emissions or his post-optimization emissions balance can be neutralized.

In some embodiments of the invention, offsets may be purchased on a one-time basis in order to offset a particular type of energy usage at a given time. According to these embodiments, the offset module is configured to provide users with the ability to select and purchase any single offset or package, or any combination thereof in any quantity.

In some embodiments of the invention, offsets are purchased on a recurring basis. Recurring offsets may be further sub-divided into two categories: fixed quantity offsets and dynamic offsets. Recurring fixed quantity offsets allow the customer to purchase the same offset amounts on a regular basis. Recurring dynamic offsets allow the customer to purchase offsets according to his estimated emissions over time.

In some embodiments of the invention, the offsetting module 314 is configured to allow the customer to further chose to offset his exact estimated emissions, or configured to choose to offset any smaller or greater amount thereof. The latter may allow the customer to become “emissions negative”. Offset purchases may qualify as charitable giving for tax purposes.

In the presently preferred embodiments of the invention, the default setting is to first recommend reducing energy usage and emissions before offsetting the remaining emissions balance. In some other embodiments, the user can skip recommendations and offset his entire emissions without first attempting to reduce them.

In some embodiments of the invention, a plurality of offsets and offset packages are available to the user from local databases 315 or networked sources 316 coupled with the offsetting module 314 via a network 317. In some embodiments, the offsets and offset packages may be managed in an offset market 319 by accredited third party vendors and they can be tagged.

In the presently preferred embodiments of the invention, the system provides a catalog of single offsets and also packaged offsets. A non-inclusive exemplary list of single offsets includes, but is not limited to: farm or landfill gas capture; reforestation projects; and clean energy investments.

In some embodiments of the invention, the offset module 314 is configured for providing offsets and offset packages in one or more feedback loops. Advantages of feedback loops include, but are not limited to: allowing the user to track the execution of his offset purchases; creating an emotional attachment to the project on behalf of the user; promoting system accountability; and promoting vendor accountability.

One example of a feedback loop includes progress reports supplied to the offset purchaser. For example, a user may sponsor a wind turbine, in which case he may receive progress reports on the purchase and installation. Another example of feedback is the physical marking of an environment. For instance a user may adopt trees in an urban area, in which case the trees could be labeled, the location shared and periodic photos can be sent to the sponsor. In another example, feedback can take the form of a site visit in which a user visits a reforestation area as part of an eco-tourism experience. Although specific examples are given, it will be apparent to those with ordinary skill in the art having the benefit of the disclosure that a wide variety of feedback can be given to users.

### Administrative Module

In the presently preferred embodiments of the invention, the processing engine 301 is also coupled with an administrative module 319. In some embodiments, the administrative module 319 is configured for providing an administrator of a hosted, browser-based interface with tools for maintaining the website, ensuring users' privacy, accounting for monetization earnings, managing developers, and ensuring security when dealing with third party applications. The administrative module 319 is preferably accessed by an operator via a unique administrative graphical user interface 320.

The administrative module 319 is also configured to maintain user profiles in a user profile database 321. User profiles are explained below in greater detail.

In the presently preferred embodiments, the administrative module 319 includes a monetization subsystem configured to track administrative earnings. Given the system's modular nature revenue sources are multiple and adaptable. Some examples of revenue sources include, but are not limited to: commissions, revenue-sharing agreements, sign-up fees, and recurring fees.

In some embodiments of the invention, the system 300 is configured to allow a system administrator to receive commissions earned on offset purchases or allowance, i.e. carbon credit, sales in the offset market. In some embodiments, a system administrator can receive commissions earned on third-party referrals made on the sale of carbon credits. In some embodiments, a system administrator can receive commissions earned on third-party referrals made via optimization recommendations, i.e. solar panel installers, insulation contractors, green energy consultants, etc.

In some embodiments of the invention, the system 300 is configured to allow a system administrator to agree to a revenue sharing agreement with a financial institution that issues a co-branded payment card to a consumer. The administrative module 319 can track energy payments and uses the energy payments to produce energy usage and emissions estimates. Likewise, payment card transactions can supply the system with energy-related data or the card's rewards program can be used to pay for recurring offsets.

In some embodiments of the invention, the system 300 is configured to allow a system administrator to agree to a revenue sharing agreement with corporations that operate the system as a hosted solution for their own customers.

In some embodiments of the invention, the system 300 is configured to allow a system administrator to allow fees are charged for extra services, such as enhanced reporting, offset project tracking, system implementation, maintenance and support, etc.

In some embodiments of the invention, the system 300 is configured to allow a system administrator to allow a system administrator to receive money in the form of one-time sign up fees or annual fees for use of the service.

### Social Module

In the presently preferred embodiments of the invention, the processing engine 301 is also coupled with a social module 322. The social module 322 is configured for allowing users to communicate with one another, participate in forums, engage in groups, etc. In the some embodiments of the invention, the social modules accesses users' profiles stored in the user profile database 321. In some embodiments, third party users t₁, t₂, t₃, . . . , tₙ can access the social module 322 via a network 323.

As explained above, the social module 322 allows customers to communicate with each other, participate in forums and engage in groups. In addition, sharing options may provide individual users with different access levels to other users' accounts. For example, a company may task an employee with administrative responsibilities on behalf of a department.

In some embodiments, the goals of the social environment include, but are not limited to information sharing, motivation, entertainment, and creating an image. Information sharing includes making the best ideas available to the community. The motivation aspect involves fostering social dynamics for energy and environment causes. The entertainment aspect involves stimulating active participation through enjoyment of the community.

Similarly, a user or a group may be interested in building a positive environmental profile and gaining recognition for accomplishments. An example would be a corporate user branding itself with a corporate responsibility image.

In some embodiments, the tools used to accomplish these goals include, but are not limited to: user forums; direct messages; comments; aggregate data and illustration of the impact achieved by the community as a whole, by individual groups or by single users; contests; quizzes; gifts; games; data feeds to news sites; data feeds to social media sites; ratings; voting; recommendations; etc.

In some embodiments of the invention, the social module is configured to allow certain users to administer or delegate rights. In addition, sharing options may provide regular users access to some or all aspects or information of another user's account. Access privileges may be governed by the established rules. For example a family may decide to share all information in its individual user accounts without creating an actual group.

### Reporting Module

In the presently preferred embodiments of the invention, the processing engine 301 is also coupled with a reporting module 324. The reporting module 324 is configured to accumulate all the information processed and managed by the various other processing modules and report the information to the users in an understandable fashion, either via a local application or a browser-based interface.

The reporting module 324 is configured to provide visibility into energy consumption, reduction, emissions and offsets. In some embodiments, reports are produced on a periodic basis, cover multiple dimensions, track accomplishments against goals, and may include projections. In some embodiments, reports are provided in energy or monetary units, and they may also utilize practical illustrations—such as comparisons or equivalents—with the intent to translate abstract notions into information that the customer can personally relate to.

In some embodiments of the invention, the reporting module 324 is configured to populate the customer's profile with data. For example, in some embodiments, the reporting module 324 attributes an energy efficiency score to the profile, which may be determined based on benchmarking against official statistics or against anonymous data from other customers. The energy efficiency score may also take into account manually provided information, such as the customer's circumstances and goals.

In some embodiments of the invention, the reporting module 324 is configured to provide visibility into energy consumption, reduction, emissions, offsets and goals by a multitude of criteria. Examples of criteria include, but are not limited to: energy usage breakdowns, energy usage roll-ups, recurring balances, projections, estimates, and benchmarks.

More specifically, in some embodiments, energy usage is presented as a breakdown by energy usage, fuel types, reduction types, offset types, etc. In some embodiments, energy usage is presented as a roll-up of aggregate information from tags, user profiles, groups, or the entire community. In some embodiments, energy usage is presented as recurring energy, emissions, reduction and offset balances. In some embodiments, energy usage is presented as projections based on past trends and potential actions (completed recommendations) taken. In some embodiments, energy usage is presented as measurements of estimates and projections against goals. In some embodiments, energy usage is presented as benchmarks against statistics and/or other users.

In the presently preferred embodiments, reports are provided in energy, power and/or monetary units, and they also utilize practical illustrations with the intent to translate abstract notions into information that the user can personally relate to. Practical illustrations of energy consumption, reductions and offsets may include, but are not limited to: equivalent number of cars, equivalent distance traveled by a given vehicle, equivalent sequestration capacity of a forest or park, comparison to the per-capita or per-household equivalent Deepwater Horizon oil spill, equivalent population area, such as a city, a state or a country, or other physical dimensions or comparisons to readily-understandable measures.

In some embodiments of the invention, reports may include offset accomplishments provided by the feedback loop, described above.

In some embodiments, reports include various representations of the data including, but not limited to: emissions per energy dollar spent [lbs of CO2/$1); distance traveled per energy dollar spent (miles/$1); energy cost per distance traveled ($/1 mile); electricity usage versus daylight hours over time; and gas usage versus outside temperature over time.

In some other embodiments reports include illustrations to visually report energy usage impact. For example, instead of presenting raw numbers, the reporting module 324 can state how many redwood trees would be required to sequester (absorb) the emissions from driving between two fuel purchases. In another example, the reporting module 324 is configured to translate average daily electricity usage into the distance that the user's body could run using that same energy.

### Interoperability Module

In the presently preferred embodiments of the invention, the processing engine 301 is also coupled with an interoperability module 325. The interoperability module 325 is configured to provide an open platform that enables communication between the system and third-party applications, websites, repositories, devices, etc. The interoperability module 325 also allows third party developers to create applications on top of the system.

In some embodiments of the invention, the interoperability module 325 is configured to allow users to share information outside of the system. For example, information may also be supplied by users on third party properties and fed into the system. Third party properties and examples include, but are not limited to: corporate websites, internal websites, business and social networks, email applications, other third-party applications, and authentication subsystems.

In a specific example, the interoperability module 325 is configured to allow users to share information to corporate websites. According to some embodiments, a company may display a carbon neutral badge on its website upon eligibility and verification. The badge would be served by the interoperability module 325.

In another specific example, the interoperability module 325 is configured to allow users to share information to internal websites. For example, information from users' professional profiles may be embedded in corporate intranets, alongside job titles and contact information.

In another specific example, the interoperability module 325 is configured to allow users to share information to business and social networks. For example, a user's offsetting accomplishments may be fed to his profile page in a social network.

In another specific example, the interoperability module 325 is configured to allow users to share information to email services. For example, upon eligibility and verification, a user may display a carbon neutral badge in his email signature. The badge would be served by the interoperability module 325.

In another specific example, the interoperability module 325 is configured to allow users to share information to other third-party applications in order to collect energy information; for example, the system may be exchanging data with one or several of the data sources described above.

In another specific example, the interoperability module 325 is configured to allow users to share information to authentication subsystems. For example, the system may access data sources indirectly or partially through authorization protocols or applications such as OAuth, OpenID or OpenSocial.

In some embodiments of the invention, the interoperability module 323 is configured to allow third party developers may create applications, so users can manage their energy and environmental lives more effectively. An example of a useful application is a mobile phone application that leverages the phone's GPS system in order to complement energy estimates. Another specific example of a useful third party application is an offset counter which can be displayed on a user's profile page in a social network.

According to FIG. 3, networks 304, 310, 313, 317, 323, etc may be the same network or different networks.

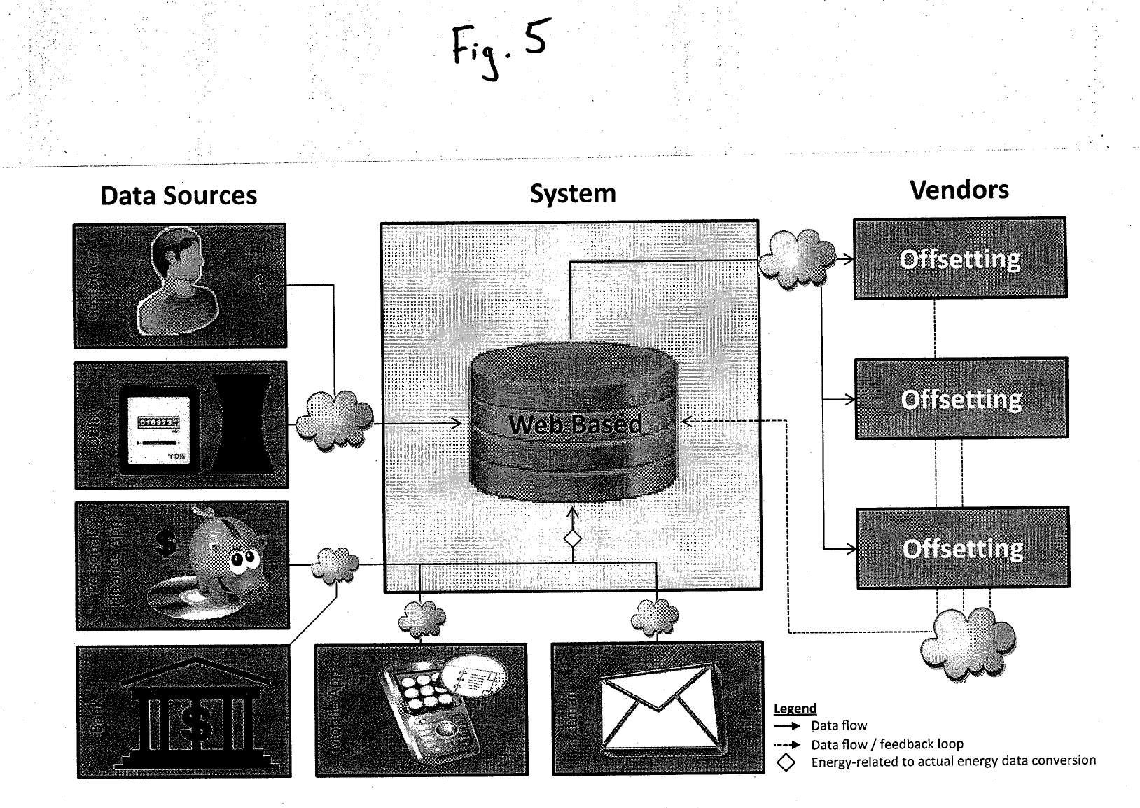

FIG. 4 is a block schematic diagram of a machine in the exemplary form of a computer system 400 within which a set of instructions may be programmed to cause the machine to execute the logic steps of the invention. In alternative embodiments, the machine may comprise a network router, a network switch, a network bridge, personal digital assistant (PDA), a cellular telephone, a Web appliance or any machine capable of executing a sequence of instructions that specify actions to be taken by that machine.

The computer system 400 includes a processor 402, a main memory 404 and a static memory 406, which communicate with each other via a bus 408. The computer system 400 may further include a display unit 410, for example, a liquid crystal display (LCD) or a cathode ray tube (CRT). The computer system 400 also includes an alphanumeric input device 412, for example, a keyboard; a cursor control device 414, for example, a mouse; a disk drive unit 416, a signal generation device 418, for example, a speaker, and a network interface device 420.

The disk drive unit 416 includes a machine-readable medium 424 on which is stored a set of executable instructions, i.e. software, 426 embodying any one, or all, of the methodologies described herein below. The software 426 is also shown to reside, completely or at least partially, within the main memory 404 and/or within the processor 402. The software 426 may further be transmitted or received over a network 428, 430 by means of a network interface device 420.

In contrast to the system 400 discussed above, a different embodiment uses logic circuitry instead of computer-executed instructions to implement processing entities. Depending upon the particular requirements of the application in the areas of speed, expense, tooling costs, and the like, this logic may be implemented by constructing an application-specific integrated circuit (ASIC) having thousands of tiny integrated transistors. Such an ASIC may be implemented with CMOS (complimentary metal oxide semiconductor), TTL (transistor-transistor logic), VLSI (very large systems integration), or another suitable construction. Other alternatives include a digital signal processing chip (DSP), discrete circuitry (such as resistors, capacitors, diodes, inductors, and transistors), field programmable gate array (FPGA), programmable logic array (PLA), programmable logic device (PLD), and the like

It is to be understood that embodiments may be used as or to support software programs or software modules executed upon some form of processing core (such as the CPU of a computer) or otherwise implemented or realized upon or within a machine or computer readable medium. A machine-readable medium includes any mechanism for storing or transmitting information in a form readable by a machine, e.g. a computer. For example, a machine readable medium includes read-only memory (ROM); random access memory (RAM); magnetic disk storage media; optical storage media; flash memory devices; electrical, optical, acoustical or other form of propagated signals, for example, carrier waves, infrared signals, digital signals, etc.; or any other type of media suitable for storing or transmitting information.

### System Landscapes

As explained above, the presently preferred embodiments of the invention involve an energy management system including a processing engine for providing energy management services to users via networked arrangements. FIGS. 5-8 illustrate various system landscapes according to some of the various embodiments of the invention. Each of the various landscapes track energy information on an ongoing basis and provides energy and emissions feedback to the user.

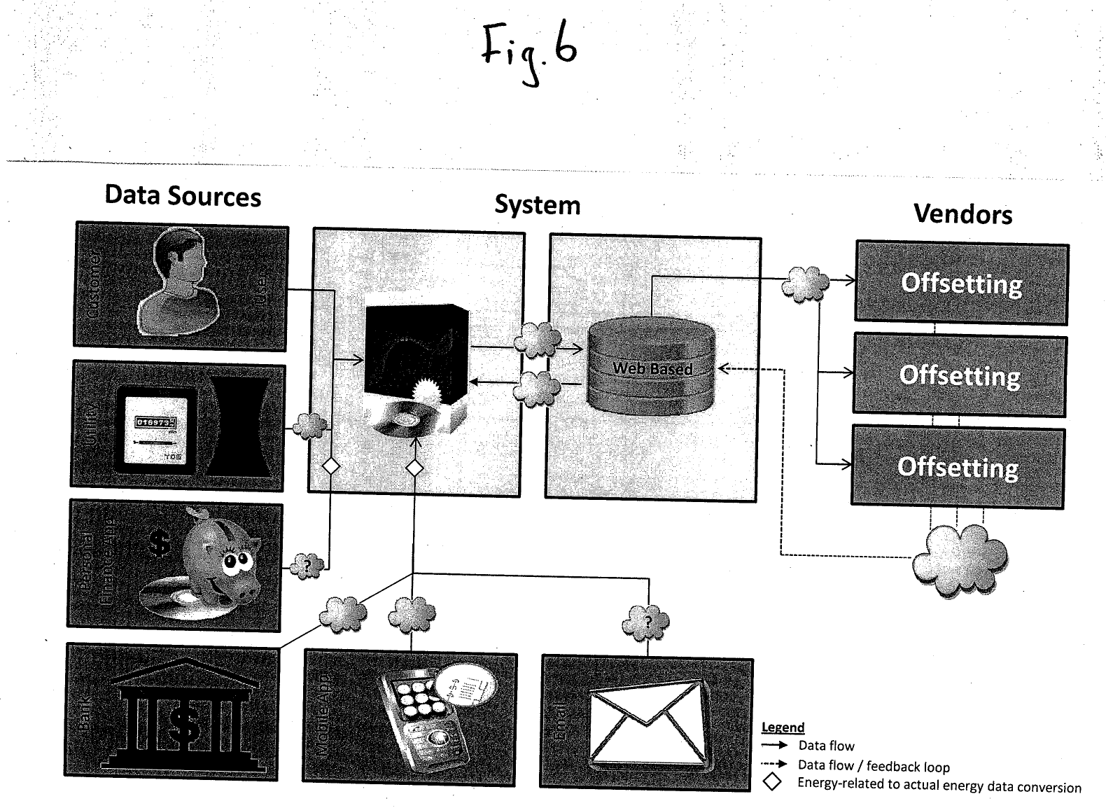

FIG. 5 illustrates a hosted consumer solution according to some embodiments of the invention. The hosted consumer solution is a fully web-based system, wherein multiple data sources allow comprehensive data collection and cross-checking. FIG. 6 illustrates a local consumer solution according to some embodiments of the invention. According to the local consumer solution, a client application collects and processes energy information and only system and offset data is passed to the web based application and back.

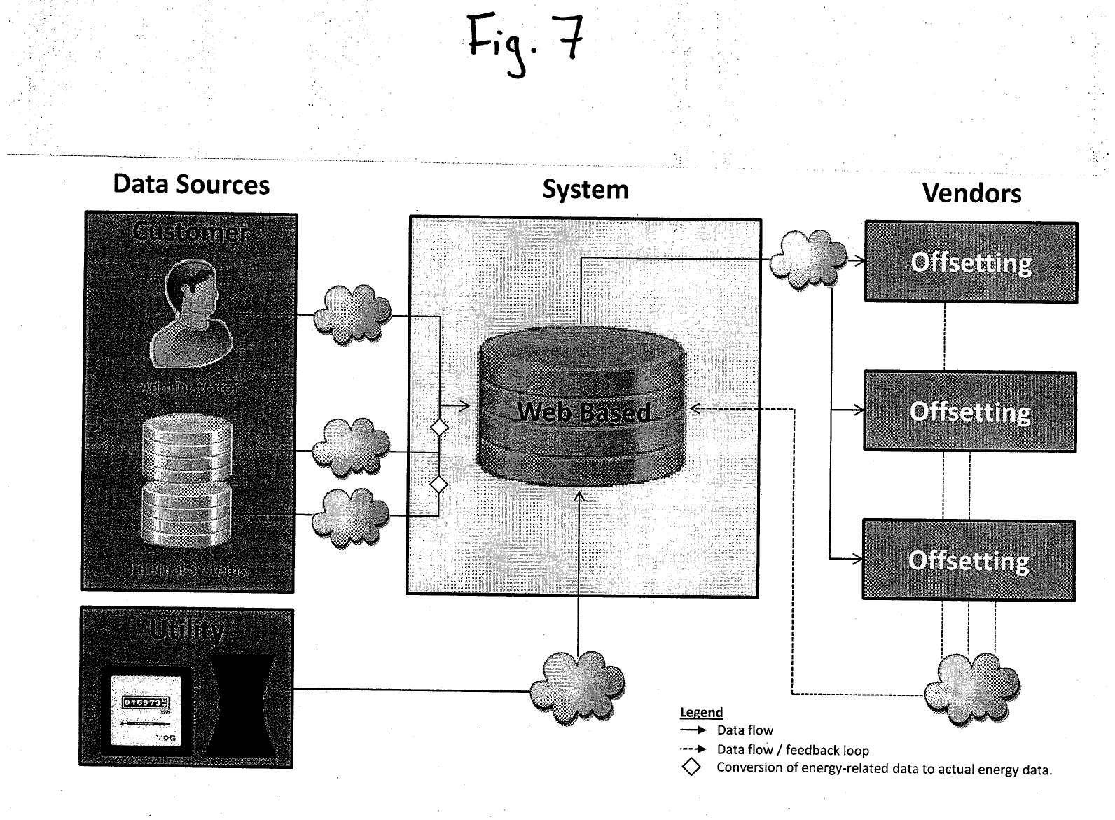

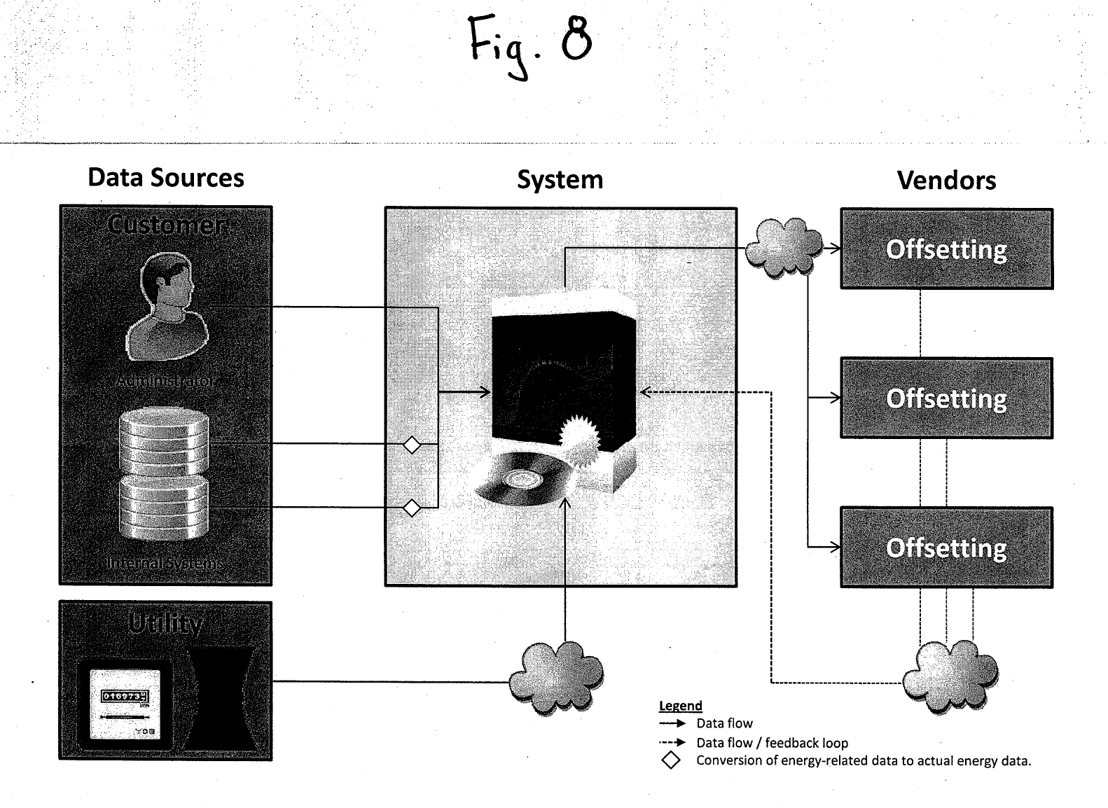

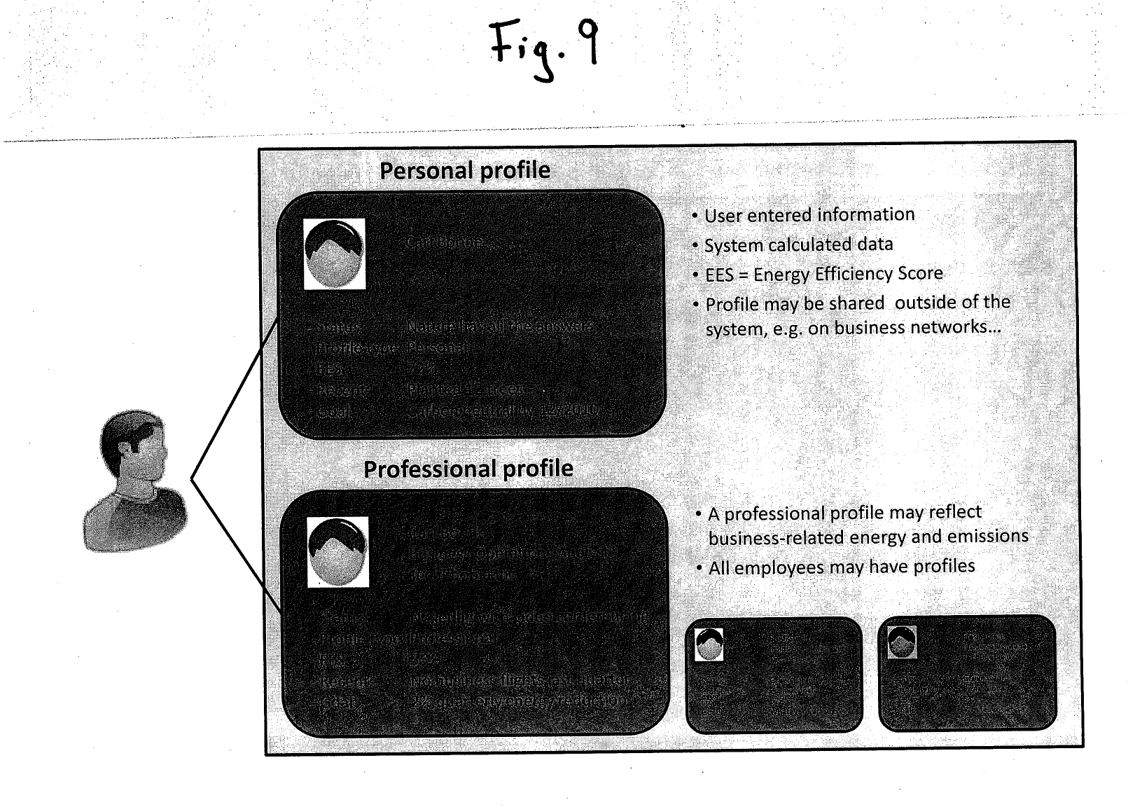

FIG. 7 illustrates a hosted corporate solution according to some embodiments of the invention. The hosted consumer solution is web-based system with both internal and external data sources. FIG. 8 illustrates a local corporate solution according to some embodiments of the invention, wherein the system is located entirely within the corporate environment.

### User Profiles

As explained above, the system offers different user types and profiles in order to enable account sharing, social features and to meet organizational requirements. FIG. 9 illustrates a representation of user profiles according to some embodiments of the invention.

The system described above may use data provided by the user and data obtained from the reporting module in order to populate the user's profile. As shown in FIG. 9, data contained in the user profile includes user provided information and energy efficiency score.

According to some embodiments, user provided information includes general information such as user name, contact information, and a status byline. User provided information can also include the user's goals.

In some embodiments, the user's Energy Efficiency Score is determined by system gauging the user's estimated energy efficiency according to his circumstances. Criteria which may be taken into account include, but are not limited to: the user's estimated energy consumption; the user's circumstances, based on home, transportation and behavioral information; and geographic and demographic statistics.

Several user types may exist to serve a variety of use cases. Typical user types include, but are not limited to: individual consumers, administrators, and delegates. More specifically, an individual consumer acts on his own behalf, whereas an administrator acts in a super-user capacity for the benefit of a group. An example of an administrator includes an Operations Analyst within a company's Facilities department. Finally, an example of a delegate includes a person who performs duties on behalf of another user, i.e. an executive assistant.

Some embodiments of the invention employ permission structures for managing the various user profiles. A permission structure may govern the rights of individual users and user types. Example permission criteria may include, but are not limited to: exclusive versus non-exclusive access; partial versus full access; and read-only versus read-and-write permissions.

### User Benefits

There are a numerous benefits from the above-described system. The value created may be of a material nature and it includes, but is not limited to: monetary savings, energy efficiency, local, state or federal incentives, potential tax breaks from charitable giving, dividends in the form of proceeds from allowances that are sold on carbon markets may be distributed to users after fees, taxes and commissions. Other material value could include: rewards (i.e. physical stickers or certificates, as well as digital badges), virtual currency (i.e. points that can be redeemed for partner merchant discounts) or recognition. The value could be informational. For example, a user can learn about energy and the environment on resource pages, in forums and from other users. Finally, value can be purely the satisfaction experienced by taking positive action, or the entertainment associated with working toward a goal.

Although the invention described herein with reference to the preferred embodiments, one skilled in the art will readily appreciate that other applications may be substituted for those set forth herein without departing from the spirit and scope of the invention. Accordingly, the invention should only be limited by the Claims included below.

1. A method for monitoring energy usage and emissions in a system of users comprising:
creating a plurality of user profiles for a plurality of system users;
obtaining energy usage information from one or more user in the system of users;
analyzing the energy usage information obtained to track energy usage and to provide energy reduction recommendations to said plurality of users; and
reporting said recommendations to said plurality of users.

2. The method of monitoring energy usage and emissions according to claim 1, further comprising:
managing said plurality of users profiles via an administrative interface operatively coupled to said plurality of users via a network.

3. The method of monitoring energy usage and emissions according to claim 2, further comprising:
providing said plurality of system users with an offset marketplace that offers energy usage offsets.

4. The method of monitoring energy usage and emissions according to claim 3, further comprising:
tracking the sale of said energy usage offsets by purchasers;
charging said purchasers with a commission for each sale of said energy usage offset; and
accounting said commission to the operator of said administrative interface.

5. The method of monitoring energy usage and emissions according to claim 2, wherein energy reduction recommendations comprise referrals to consult with businesses offering energy reducing services.

6. The method of monitoring energy usage and emissions according to claim 5, further comprising:
tracking said referrals;
charging said businesses with a commission upon a user acting on said referral; and
accounting said commission to the operator of said administrative interface.

7. The method of monitoring energy usage and emissions according to claim 2, further comprising:
charging each of said plurality of system users with at least one fee for access to said profile and said recommendations; and
accounting said at least one fee to the operator of said administrative interface.

8. The method of monitoring energy usage and emissions according to claim 1, wherein the step of obtaining energy usage information further comprises one or more users from among said plurality of system users manually uploading energy usage information.

9. The method of monitoring energy usage and emissions according to claim 1, wherein the step of obtaining energy usage information further comprises automatically obtaining energy usage information by data mining said one or more users' financial records to determine an amount of money spent on energy

10. The method of monitoring energy usage and emissions according to claim 9, wherein said financial records are selected from among a group consisting of smart meter hardware and software; online utility accounts; travel planning tools, environmental data providers, energy monitors, vehicle electronics, financial institution accounts; billing or payment notifications; payment transactions; personal finance software; corporate finance applications; Enterprise Resource Planning (ERP) systems; and Customer Relationship Management (CRM) systems.

11. The method of monitoring energy usage and emissions according to claim 9, wherein the step of automatically obtaining energy usage information further comprises calculating the amount of energy used by each of said one or more users by dividing the amount of money spent on energy by the cost per unit of energy.

12. The method of monitoring energy usage and emissions according to claim 9, wherein data mining said one or more users' financial records comprises linking at least one user profile with a personal finance software application configured for determining an amount of money spent on energy by said at least one user.

13. The method of monitoring energy usage and emissions according to claim 1, further comprising:
allowing a first user from among said plurality of users and at least one additional user from among said plurality of users to interact via a social interface.

14. The method of monitoring energy usage and emissions according to claim 2, further comprising:
configuring said administrative interface with an application programming interface (API); and
conditionally allowing at least one third-party developer access to said system of users via said API.

15. The method of monitoring energy usage and emissions according to claim 9, wherein the step of automatically obtaining energy usage information further comprises performing Enhanced Level II and Level III data capture techniques

16. An energy management system comprising:
an energy management processing engine comprising a processing core operatively coupled with at least one memory device and a network interface, wherein said energy management processing engine is operatively coupled with a plurality of users via said network interface, and wherein said plurality of users access said energy management processing engine via a browser-based graphical user interface;
an energy assessment module operatively coupled with said energy management processing engine, wherein said energy assessment module is configured for obtaining energy data from said plurality of users;
an energy optimization module operatively coupled with said energy management processing engine, wherein said energy optimization module is configured to analyze said energy data and to provide energy reduction recommendations to said plurality of users for reducing their energy usage; and
a reporting module configured for reporting said recommendations to said plurality of users.

17. The energy management system according to claim 16, wherein said energy assessment module is configured to access personal financial records of at least one user, and wherein said energy assessment module is configured for automatically obtaining energy data by data-mining said personal financial records.

18. The energy management system according to claim 16, wherein said energy assessment module is configured to accept manually uploaded energy data from at least one user.

19. The energy management system according to claim 16, further comprising an administrative accounting module configured for managing accounts for said plurality of users.

20. The energy management system according to claim 19, further comprising an energy offset marketplace module configured for providing said plurality of users with a point of sale for energy offsets.

21. The energy management system according to claim 20, wherein said administrative accounting module is further configured for tracking the sale of said energy usage offsets by purchasers, charging said purchasers with a commission for each sale of said energy usage offset, and accounting said commission to the operator of said administrative interface.

22. The energy management system according to claim 19, wherein said energy optimization module provides energy reduction recommendations in the form of referrals to consult with businesses offering energy reducing services.

23. The energy management system according to claim 22, wherein said administrative accounting module is further configured for tracking said referrals, charging said businesses with a commission upon a user acting on said referral, and accounting said commission to the operator of said administrative interface.

24. The energy management system according to claim 16, further comprising a social module configured for allowing a first user from among said plurality of users and at least one additional user from among said plurality of users to interact via a graphical user interface.

25. The energy management system according to claim 16, further comprising an interoperability module configured for conditionally allowing third-party developers access to said energy management system via an application programming interface (API).

26. An energy management system comprising:
an energy management processing engine comprising a processing core operatively coupled with at least one memory device and a network interface, wherein said energy management processing engine is operatively coupled with a plurality of users via said network interface, and wherein said plurality of users access said energy management processing engine via a local client application;
wherein said local client application comprises:
an energy assessment module configured for obtaining energy data from the user of said local client application;
an energy optimization module operatively coupled with said energy management processing engine, wherein said energy optimization module is configured to analyze said energy data and to provide energy reduction recommendations to said user for reducing energy usage; and
a reporting module configured for reporting said energy data to said energy management processing engine and for reporting said recommendations to said user
wherein said energy management processing engine further comprises:
an administrative accounting module configured for managing accounts for said plurality of users;
an energy offset marketplace module configured for providing said plurality of users with a point of sale for energy offsets based on said reporting of said energy data by said local client application.

27. The energy management system according to claim 26, wherein said administrative accounting module is further configured for tracking the sale of said energy usage offsets by purchasers, charging said purchasers with a commission for each sale of said energy usage offset, and accounting said commission to the operator of said administrative interface.

28. The energy management system according to claim 26, wherein said energy optimization module provides energy reduction recommendations in the form of referrals to consult with businesses offering energy reducing services.

29. The energy management system according to claim 28, wherein said administrative accounting module is further configured for tracking said referrals, charging said businesses with a commission upon a user acting on said referral, and accounting said commission to the operator of said administrative interface.
